(19) United States
(12) Patent Application Publication
(10) Pub. No.: US 2026/0237399 A1
(43) Pub. Date: Aug. 13, 2026

(54) DEVICE, SYSTEM, AND METHOD FOR OBTAINING AND ENCODING INFORMATION INTO A COMMUNICATION SESSION

(71) Applicant: MOTOROLA SOLUTIONS, INC., Chicago, IL (US)

(72) Inventors: Chun Wen OOI, Georgetown (MY); Intan Mazlina MOHD MOHDI, Bayan Lepas (MY); Wei Chun LIM, Bayan Lepas (MY); Wooi Ping TEOH, Tanjung Tokong (MY)

(21) Appl. No.: 19/049,423

(22) Filed: Feb. 10, 2025

(51) Int. Cl. G10L 25/60; G10L 19/018; G10L 25/69

(52) U.S. Cl. CPC G10L 25/60; G10L 19/018; G10L 25/69

(57) ABSTRACT

A computing device analyzes a voice transmission in a communication session between communication devices, to detect degraded voice quality in the voice transmission. The computing devices determines a type of information, associated with the voice transmission, that is missing, or degraded, due to the degraded voice quality, and obtains the information based on the type. The computing device generates one or more of audio data and text data with the information, as obtained, encoded therein. The computing device provides one or more of the audio data and the text data, with the information encoded therein, in the communication session.

### BACKGROUND OF THE INVENTION

Public safety answering points (PSAPs), and the like, rely on continuous vocal communication, often facilitated by computer-driven voice recognition. When users experience physical difficulty in speaking due to conditions like laryngitis or environmental factors such as smoke exposure, these systems encounter degraded input quality, leading to increased error rates in voice recognition, dispatch processing, and the like. Regardless, such degraded inputs can cause misinterpretation and/or poor processing of commands or data, leading to inefficiencies in computer-based PSAP systems, and the like, which may lead to increased computational load due to repeated processing attempts or error correction. For example, additional processing cycles needed to interpret hoarse or unclear inputs, or manage incomplete data, may result in slower response times and reduced overall system performance. In addition, when a PSAP is experiencing a high volume of calls, it is imperative to process each call quickly and efficiently, to reduce the number of calls, and/or reduce strains on bandwidth and/or processing resources; indeed, additional processing cycles may cause strains on such bandwidth and/or processing resources.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a system for obtaining and encoding information into a communication session, in accordance with some examples.

FIG. 2 is a device diagram showing a device structure of a computing device for obtaining and encoding information into a communication session, in accordance with some examples.

FIG. 3 is a flowchart of a process for obtaining and encoding information into a communication session, in accordance with some examples.

FIG. 4 depicts the system of FIG. 1 implementing aspects of a process for obtaining and encoding information into a communication session, in accordance with some examples.

FIG. 5 depicts the system of FIG. 1 continuing to implement aspects of a process for obtaining and encoding information into a communication session, in accordance with some examples.

FIG. 6 depicts the system of FIG. 1 continuing to implement aspects of a process for obtaining and encoding information into a communication session, in accordance with some examples.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

At public safety answering points (PSAPs), and the like, call taking resources, may be overwhelmed due to high call volumes. Hence, it is imperative that calls be processed as quickly and efficiently as possible. Such processing may be severely degraded when a voice transmission in a communication session (e.g., a call being processed by a PSAP), has degraded voice quality, and the like. Furthermore, efforts by a user experiencing voice degradation may experience further physical strain on their throats if they attempt to clarify information that may have been missing in a voice transmission due to their voice degradation.

Thus, there exists a need for an improved technical method, device, and system for obtaining and encoding information into a communication session.

An aspect of the present specification provides a method comprising: analyzing, via a computing device, a voice transmission in a communication session between communication devices, to detect degraded voice quality in the voice transmission; determining, via the computing device, a type of information, associated with the voice transmission, that is missing, or degraded, due to the degraded voice quality; obtaining, via the computing device, the information based on the type; generating, via the computing device, one or more of audio data and text data with the information, as obtained, encoded therein; and providing, via the computing device, one or more of the audio data and the text data, with the information encoded therein, in the communication session.

Another aspect of the present specification provides a computing device comprising: a controller; and a computer-readable storage medium having stored thereon program instructions that, when executed by the controller, causes the controller to perform a set of operations comprising: analyzing a voice transmission in a communication session between communication devices, to detect degraded voice quality in the voice transmission; determining a type of information, associated with the voice transmission, that is missing, or degraded, due to the degraded voice quality; obtaining the information based on the type; generating one or more of audio data and text data with the information, as obtained, encoded therein; and providing one or more of the audio data and the text data, with the information encoded therein, in the communication session.

Each of the above-mentioned aspects will be discussed in more detail below, starting with example system and device architectures of the system, in which the embodiments may be practiced, followed by an illustration of processing blocks for achieving an improved technical method, device, and system for obtaining and encoding information into a communication session.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions, which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

As used herein, the term “engine” refers to hardware (e.g., a processor, such as a central processing unit (CPU), graphics processing unit (GPU), a tensor processing unit (TPU), or similar parallel processing units optimized for handling large-scale data and complex machine learning models, an integrated circuit or other circuitry) or a combination of hardware and software (e.g., programming such as machine-or processor-executable instructions, commands, or code such as firmware, a device driver, programming, object code, etc. as stored on hardware). Hardware includes a hardware element with no software elements such as an application specific integrated circuit (ASIC), a Field Programmable Gate Array (FPGA), a PAL (programmable array logic), a PLA (programmable logic array), a PLD (programmable logic device), etc.

Further advantages and features consistent with this disclosure will be set forth in the following detailed description, with reference to the drawings.

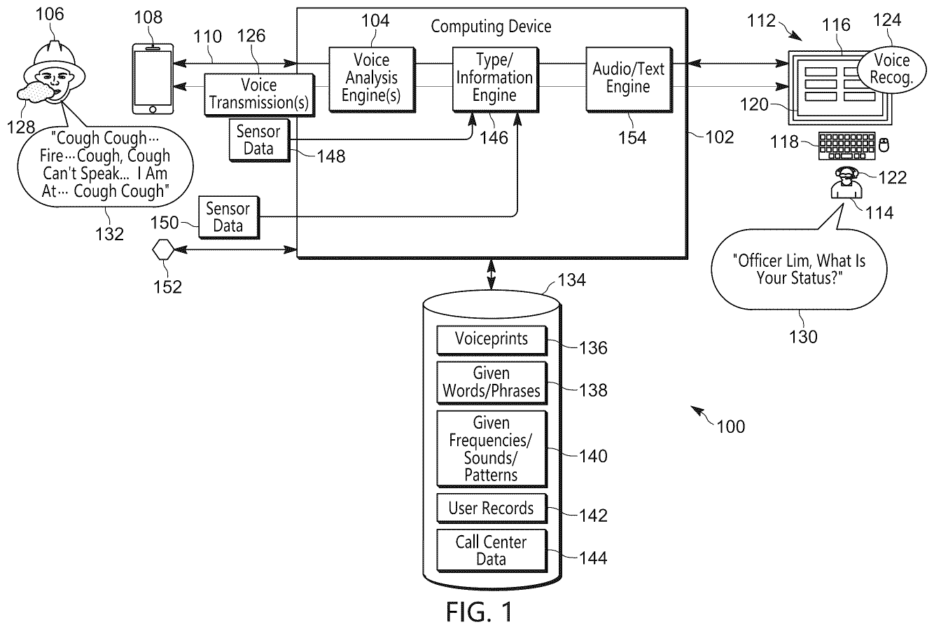

Attention is directed to FIG. 1, which depicts a system 100 for obtaining and encoding information into a communication session, in accordance with present examples. The various components of the system 100 are communicatively coupled and/or in communication via any suitable combination of wired and/or wireless communication links, and communication links between components of the system 100 are depicted in FIG. 1, and throughout the present specification, as double-ended arrows between respective components; the communication links may include any suitable combination of wireless and/or wired links and/or wireless and/or wired communication networks, and the like.

The system 100 comprises a computing device 102, which may be a component of a PSAP and/or may be provided in the form of a PSAP device. As depicted, the computing device 102 is implementing one or more voice analysis engines 104, that may assist with calls to the computing device 102 as described herein. For example, as depicted, a user 106 has operated a communication device 108 to initiate a communication session 110 with a terminal 112 associated with the computing device 102, and/or a terminal operator 114 may have initiated the communication session 110. The communication session 110 may be in the form a call and/or a phone call, and/or may alternatively be in form of a voice communication session using an internet protocol (IP)-based messaging application. It is further understood that, in some examples, text data may be exchanged between the communication device 108 and the terminal 112 in the communication session 110, though it is understood that the communication session 110 allows for voice communication between the user 106 and the operator 114.

In particular, the user 106 may be a first responder, such as a firefighter (e.g., as depicted), and the communication device 108 may comprise a radio operated by the first responder. While the user 106 is depicted as a firefighter, the user 106 may be any suitable type of first responder, including, but not limited to, a police officer, a firefighter, an emergency medical technician, and the like. Similarly, the operator 114 may be a PSAP operator and/or dispatcher. In these examples, the operator 114 may be attempting to communicate with the user 106 in a critical and/or emergency environment where health of the user 106 may be at risk.

Alternatively, the user 106 may be any member of the general public using a cell phone, and/or a messaging/calling application and the like, to call a PSAP represented by the computing device 102, for example to report a crime and/or incident, and/or to discuss a mental health number, using an emergency number such as “911”, and/or “988”, and the like.

Hence, the communication device 108 may comprise one or more of a radio, a mobile phone, a personal computer, a laptop, and the like. When the user 106 comprises a first responder, the communication device 108 may comprise a first responder communication device and/or radio. Regardless, the communication device 108 is understood to include any suitable combination of input and output components for conducting voice communications, and that may include a combination of a speaker and a microphone, and, as depicted, a display screen, as well as a touchscreen, a keyboard (e.g., an electronic keyboard) and/or a pointing device, and the like.

The terminal 112 may comprise a PSAP call answering terminal and/or dispatch terminal and the like. The terminal 112 may comprise any suitable combination of input and output devices that enable the operator 114 to conduct communication sessions, such as the communication session 110, for example with the communication device 108. As depicted, the terminal 112 comprises a display screen 116 and an input device 118 (e.g., as depicted, keyboard, as depicted, a pointing device and/or any other suitable input device). However, the terminal 112, the display screen 116 and the input device 118 may be provided in any suitable format, such as a laptop, a personal computer, and the like. In general, the display screen 116 and the input device 118 may be used to interact with the terminal 112, for example via an interface 120 (which may include, but is not limited to, a VR interface) provided at the display screen 116, and the like. The terminal 112 further comprises a communication device, for example as represented in FIG. 1 by a headset 122 worn by the operator 114.

As also depicted, the terminal 112 may be implementing a voice recognition engine 124, which may transcribe voice transmissions 126 in the communication session 110, which may include, but is not limited to, voice transmissions received at the terminal 112 from the communication device 108, and/or voice transmissions received at the communication device 108 from the terminal 112. Alternatively, or in addition, the voice recognition engine 124 may be implemented by the computing device 102 and/or the communication device 108. For example, the voice recognition engine 124 may be dedicated to generating a transcript of communication sessions that include the terminal 112, that may act as a record of such communication sessions, for example for evidentiary purposes, and the like. It is hence imperative, at least in first responder environments, that such transcripts be accurate. Alternatively, or in addition, the voice recognition engine 124 may be a component of an automated call answering system (not depicted) implemented by the computing device 102. When voice in the voice transmissions 126 is degraded, the voice recognition engine 124 may not properly transcribe the voice transmissions 126.

Regardless, the voice recognition engine 124, when present, may convert the voice transmissions 126, received in the communication session 110 to text, and the like. When the voice recognition engine 124 is a component of an automated call answering system, the automated call answering system may conversely provide audio data and/or text data in the communication session 110 that responds to voice transmissions 126 received from the communication device 108.

As has already been explained, as depicted, the user 106 may be a firefighter and may be attempting to communicate with the operator 114 and/or the voice recognition engine 124 (e.g., the automated call answering system) via the voice transmissions 126 in the communication session 110. However, as depicted, the firefighter (e.g., the user 106) may be in a smoky environment, as represented by smoke 128 adjacent a mouth of the user 106. As such, a voice of the user 106 may be degraded due to: the smoke 128 and/or laryngitis (e.g., which may be caused by the smoke 128, inhalation/exposure to chemical fumes, and/or allergens and the like, amongst other possibilities), and/or the voice of the user 106 may be degraded due to any other suitable reason (e.g., a virus, vocal cord damage and the like, amongst other possibilities).

Hence, for example, while the operator 114 may be attempting to ask the user 106 their status, as depicted in a speech bubble 130 as “Officer Lim, what is your status?”, voice of the user 106 may be degraded, and the user 106 may not be able to properly reply, as depicted in a speech bubble 132 as “cough cough. . . Fire . . . cough, cough, can't speak . . . I am at . . . cough cough”, where “cough” represents the user 106 coughing (e.g., and not saying the word “cough”). In particular, it is apparent that the user 106 is attempting to convey information in the voice transmissions 126, but that some information is missing and/or degraded due to the user 106 being unable to speak. Furthermore, it is apparent that the information regarding a “fire” and a location of the user 106 is missing in the speech bubble 130, and that may be generally related to the status of the user 106 as requested by the operator 114. In particular, information being degraded may include, but is not limited to, only portions of a word and/or a phrase being present the voice transmissions 126. For example, rather than “there is a fire”, the user 106 has only said “fire” which, alone, may not indicate the presence of a fire; alternatively, or in addition, while not depicted, the user 106 may say “fi . . . ” which is only a portion of the word “fire”.

It is further understood that voice transmissions 126 comprises the voices of the user 106 and the operator 114, as represented by the text in the speech bubbles 130, 132, and hence may be analyzed by the voice analysis engines 104 (e.g., hereafter interchangeably referred to as the voice analysis engine 104 for simplicity).

While present examples are described with respect to the user 106 having a degraded voice, in other examples, the operator 114 may have a degraded voice and processes described herein may be applied to a voice of the operator 114 in the voice transmissions 126 (e.g. rather than the voice of the user 106). Though, in further examples, respective voices of both the user 106 and the operator 114 may be degraded.

As such, the computing device 102 may be generally configured to analyze the voice transmissions 126, in the communication session 110 to detect degraded voice quality in the voice transmissions 126. For example, the voice transmissions 126 may be analyzed by the voice analysis engine 104 to detect degraded voice quality of the voice transmissions 126.

To assist with such detection, as depicted, the system 100 further comprises a memory 134 (e.g., which, as depicted, may be provided in the form of a database) storing one or more of a voiceprint 136 of the user 106 (e.g. and/or voiceprints 136 of a plurality of users), given words and/or given phrases 138, and given frequencies and/or given sounds and/or given patterns 140.

For example, the voiceprint 136 may comprise a prepopulated voiceprint of the user 106 when not experiencing degraded voice issues; put another way, the voiceprint 136 may represent a voiceprint of a “normal” voiceprint of the user 106. For example, the user 106 may register the voiceprint 136 as part of a registration process with the system 100 when the user 106 is not experiencing a degraded voice. The voiceprint 136 may comprise a (e.g., unique) digital representation of the voice of the user 106 and may be generated by analyzing various vocal attributes of the voice of the user 106, that may include, but is not limited to, pitch, tone, rhythm, and frequency patterns. Hence, in these examples, to determine whether a voice of the user 106 is degraded, the voice analysis engine 104 may compare the portion of the voice transmissions 126 corresponding to the speech bubble 132 with the voiceprint 136 to determine whether the voice of the user 106 is degraded. For example, pitch, tone, rhythm, and frequency patterns of the user 106, as represented by the portion of the voice transmissions 126 corresponding to the speech bubble 132, may be different from pitch, tone, rhythm, and frequency patterns of normal voice of the user 106, as represented by the voiceprint 136. Such an example, further assumes that the voiceprint 136 is stored in association with an identifier of the user 106 (e.g., a badge number, an employee number, and the like) and that the identifier of the user 106 is available to the voice analysis engine 104; for example, the identifier of the user 106 may be stored at the communication device 108 and provided as metadata in the voice transmissions 126 by the communication device 108, and the like.

Put another way, in such examples, the voice analysis engine 104 may be configured to generate a voiceprint of the user 106 based on a voice of the user 106 in the voice transmissions 126, and compare the generated voiceprint with the stored voiceprint 136 to determine differences therebetween. Such differences may represent a degraded voice of the user 106.

It is further understood that a plurality of voiceprints 136 may be stored at the memory 134, for example a voiceprint 136 for each user registered with the system 100 (e.g., the user 106, and other firefighters, and the operator 114, and other operators). Alternatively, or in addition, when members of the general public call the computing device 102, such calls may be used to generate respective voiceprints 136 for such users that may be stored at the memory 134 in association with respective identifiers.

Alternatively, or in addition, to determine whether a voice of the user 106 is degraded, the voice analysis engine 104 may compare words and/or phrases that occur in the portion of the voice transmissions 126 corresponding to the speech bubble 132 with the given words and/or phrases 138 stored at the memory 134. For example, the given words and/or phrases 138 stored at the memory 134 may include, but are not limited to, “can't speak”, “hoarse”, “voice lost”, “struggling to talk”, and the like. In the depicted example, the voice analysis engine 104 may determine that a voice of the user 106 is degraded as the portion of the voice transmissions 126 corresponding to the speech bubble 132 includes the phrase “can't speak”, which may be present in the given words and/or phrases 138 stored at the memory 134.

Alternatively, or in addition, to determine whether a voice of the user 106 is degraded, the voice analysis engine 104 may comprise a spectrum analyzer that determines frequencies and/or sounds and/or patterns in the portion of the voice transmissions 126 corresponding to the speech bubble 132, and that compares such frequencies and/or sounds and/or patterns to the given frequencies and/or sounds and/or patterns 140 stored at the memory 134. For example, the given frequencies and/or sounds and/or patterns 140 stored at the memory 134 may include, but are not limited to, given frequencies and/or sounds and/or patterns corresponding to coughing, throat clearing, and the like. Hence, the voice analysis engine 104 may determine that a voice of the user 106 is degraded as the portion of the voice transmissions 126 corresponding to the speech bubble 132 includes given frequencies and/or sounds and/or patterns corresponding to coughing, and the like, and that appear in the given frequencies and/or sounds and/or patterns 140 stored at the memory 134.

Furthermore, at least via the voiceprint 136 of the user 106 and/or by tracking changes in one or more of frequencies and/or sounds and/or patterns of a voice of the user 106, and/or changes in words and/or phrases used by the user 106, the voice analysis engine 104 may detect degraded voice quality in the voice transmission 126 by determining a change in speech in the voice transmission 126. For example frequencies and/or sounds and/or patterns in a voice of the user 106 may change over time.

Alternatively, or in addition, the voice analysis engine 104 may comprise a machine learning algorithm, and the like, trained to detect degraded voice quality in a voice transmission, using one or more of given words and/or phrases 138 and the given frequencies and/or sounds and/or patterns 140. For example, given words and/or phrases 138 and the given frequencies and/or sounds and/or patterns 140 may be used as training data to train the voice analysis engine 104 that presence, in a voice transmission, of one or more of given words and/or phrases 138 and/or one or more of the given frequencies and/or sounds and/or patterns 140 indicates degraded voice quality.

As depicted, the memory 134 further stores user records 142, which may store personal and/or employment information about the user 106, and other users and/or operators registered with the system 100, and that may include, but is not limited to, employees records, and the like. However, the user records 142 may further store records of users who may have previously called into the computing device 102, including, but not limited to, members of the general public. Indeed, the voiceprints 136 may optionally be stored in the user records 142.

As depicted, the memory 134 further stores call center data 144, which may include, but is not limited to, scripts that the operator 114 and/or an automated call answering system may follow when communicating with users, and which may be incident-type dependent. For example, as depicted, the question in the speech bubble 130 of “what is your status?” may be a first question in such a script (e.g., for a fire incident), and a next question may be “what is your location?”.

However, the user records 142 and/or the call center data 144 may further include information identifying an incident and/or geographic address to which the user 106 has been dispatched, and the like. Hence, the user records 142 and/or the call center data 144 may further comprise incident records, and the like.

As depicted, the computing device 102 may further implement an engine 146 configured to determine a type of information, associated with the voice transmission 126, that is missing, or degraded, due to the degraded voice quality of the user 106, as determined by the voice analysis engine 104.

The engine 146 may be further configured to obtain the information based on the determined type of information.

While for simplicity, the engine 146 is described herein as both determining a type of information that is missing, or degraded, due to the degraded voice quality of the user 106, and obtaining such information, in other examples the functionality of the engine 146 may be divided into different engines, and the like. The engine 146 is hence labelled as being a type/information engine, and may hence include a “type determining engine” and an “information determining engine”.

Furthermore, the engine 146 may comprise one or more machine learning algorithms trained to determine a type of information that is missing, or degraded, due to the degraded voice quality in a voice transmission and/or trained to obtain such information. Training data may include, but is not limited, predetermined inputs that correspond to predetermine status outputs, and/or training data may include, but is not limited, predetermined status inputs that correspond to predetermined information outputs, as well as any suitable other information as inputs, including predetermined sensor data, and the like.

In particular, the engine 146 determining a type of information that is missing, or degraded, due to the degraded voice quality of the user 106 may be based on the voice transmission 126, such as the portion of the voice transmission 126 corresponding to the speech bubble 130 including the term “status”. In this example, the term “status” may indicate that the type of information that is missing, or degraded, due to the degraded voice quality of the user 106 is a status of the user 106. Indeed, herein, the term “status” may specifically refer to a status of first responders that are responding to an incident.

Alternatively, or in addition, the engine 146 determining a type of information that is missing, or degraded, due to the degraded voice quality of the user 106 may be based on an information request received in the voice transmission 126. In such examples, voice in the speech bubble 130 may be received at the computing device 102 in the voice transmissions 126 that may specifically request a type of information.

Hence, in these examples, the term “what is your status” the speech bubble 130 may comprise an information request that indicates that the type of information that is missing, or degraded, due to the degraded voice quality of the user 106 is a status of the user 106. Indeed, such an example is similar to the aforementioned determining a type of information based on the voice transmission 126 itself.

However, in these examples, the portion of the voice transmission 126 that precede the portion of the voice transmission 126 that includes the degraded voice may be analyzed for specific words and/or phrases to determine whether an information request was received; indeed, such words and/or phrases may further be present in a script that the operator 114 is following, and whether or not an information request is received may be determined by comparing words and/or phrases in such a script with words and/or phrases in the voice transmissions 126.

However, any suitable process for determining the type of information that is missing, or degraded, due to the degraded voice quality of the user 106 is within the scope of the present specification.

Furthermore, any suitable type of type of information may be missing, or degraded, due to the degraded voice quality of the user 106 including, but not limited to, a location of the user 106, descriptions of the environment of the user 106, descriptions of suspects and/or other people seen by the user 106, and the like, amongst other possibilities.

The engine 146 may further obtain such information that is missing based on the type.

For example, obtaining the information based on the type may occur using sensor data 148, 150 associated with the communication session 110, and that may be provided to the computing device 102 and/or the engine 146 by the communication device 108 and/or a sensor 152, described herein.

For example, the communication device 108 may comprise one or more sensors (not depicted, but represented by the communication device 108), that may include, but is not limited to, a camera, a location determining device (e.g., including, but not limited to, a Global Positioning System (GPS) device, and the like), amongst other possibilities. Such sensors may acquire sensor data 148, and the communication device 108 may provide the sensor data 148 to the computing device 102, and/or the engine 146 for analysis.

When the communication device 108 comprises a camera, and the like, that may provide sensor data 148 in the form of images and/or video of the user 106 and/or an environment of the user 106, such images and/or video may be analyzed by the engine 146 to determine information that indicates the status of the user 106, and/or any other suitable information of any suitable type of information that may be missing, or degraded, in the voice transmissions 126 due to the degraded voice quality of the user 106. For example, such images and/or video may show the user 106 being in a building on fire and/or suspect and/or people in the environment of the user 106.

Alternatively, or in addition, the communication device 108 may comprise a location determining device and corresponding sensor data 148 may include a location of the user 106.

As depicted, the system 100 may further comprise one or more sensors 152, at the location of the user 106, that may sense environmental conditions at the location. Such one or more sensors 152 are communicatively coupled to the computing device 102, acquire sensor data 150, and provide the sensor data 148 to the computing device 102, and/or the engine 146 for analysis.

The one or more sensors 152 may include, but are not limited to, smoke detectors, gas detectors (e.g., carbon monoxide detectors, chlorine gas detectors, and the like), heat sensors, and the like. While such examples may be specific to fires, the one or more sensors 152 may include any suitable sensors, including, but not limited to, one or more cameras (e.g., components of a video monitoring system at the location of the user 106).

The sensor data 150 may include, but is not limited to, data that indicates presence of one or more of smoke, heat and/or a particular type of gas at the location of the user 106, and/or images that may indicate a status of the user 106.

Hence, in general, the sensor data 150 may be analyzed by the engine 146 to determine information that indicates the status of the user 106, and/or any other suitable information of any suitable type of information that may be missing, or degraded, in the voice transmissions 126 due to the degraded voice quality of the user 106

Alternatively, or in addition, obtaining the information based on the type may occur using the aforementioned information request. For example, as the speech bubble 130 indicates that a “status” of the user 106 is the type of information missing, the engine 146 may process the sensor data 148, 150 to specifically determine the status. In other examples, a location of the user 106 may be the type of information missing, and the engine 146 may process the sensor data 148, 150 to specifically determine the location of the user 106. In other examples, a description of the environment of the user 106 and/or a suspect and/or a person seen by the user 106, and the like, may be the type of information missing, and the engine 146 may process the sensor data 148, 150 to specifically determine a description of the environment of the user 106 and/or a description of a suspect and/or a person seen by the user 106, for example by processing images received in the sensor data 148, 150.

Alternatively, or in addition, obtaining the information based on the type may occur using user records 142 and/or call center data 144 associated with the communication session 110. For example, as the speech bubble 130 indicates that a “status” of the user 106 is the type of information missing, the user records 142 and/or call center data 144 may indicate that the user 106 has been dispatched to a particular incident, for example to a particular geographic address. As such, the engine 146 may at least partially determine the status of the user 106 using such incident information and/or particular geographic address, and confirm the location of the user 106 at the address via the sensor data 148, 150.

The computing device 102 may generate one or more of audio data and text data, with the information (e.g., obtained by the engine 146), encoded therein. For example, the engine 146 may provide the obtained information to an audio and/or text engine 154, which may convert the information to audio data and/or text data, and provide one or more of the audio data and the text data, with the information encoded therein, in the communication session 110. In some examples, the audio and/or text engine 154 may be a component of the aforementioned automatic call answering system. In particular examples, the audio and/or text engine 154 may comprise a large language model (LLM) that receives, as input, information from the engine 146, and outputs corresponding text data, that may be converted to audio data using a text-to-speech module of the text engine 154, and the like.

While the engines 104, 146, 154 are described as being separate from each other, functionality of one or more of the engines 104, 146, 154, or all of the engines 104, 146, 154, may be combined in any suitable manner.

Regardless, returning to example of the type of information missing in the voice transmission 126 being a status of the user 106, the audio and/or text engine 154 may provide the determined status of the user 106 in the communication session 110, such that at least the terminal 112 and/or the voice recognition engine 124 receives the determined status. Indeed, as the determined status of the user 106 may now be clearly provided as audio data and/or text data, the voice recognition engine 124 may easily convert the audio data to text and/or store the text data, reducing processing cycles at the voice recognition engine 124. Alternatively, or in addition, as the determined status of the user 106 may now be clearly provided as audio data and/or text data to the terminal 112, the operator 114 may then proceed to a next step in a script and/or may dispatch assistance to the user 106 accordingly, which may also reduce processing cycles at the terminal 112 as further communication with the user 106, to determine their status, is obviated.

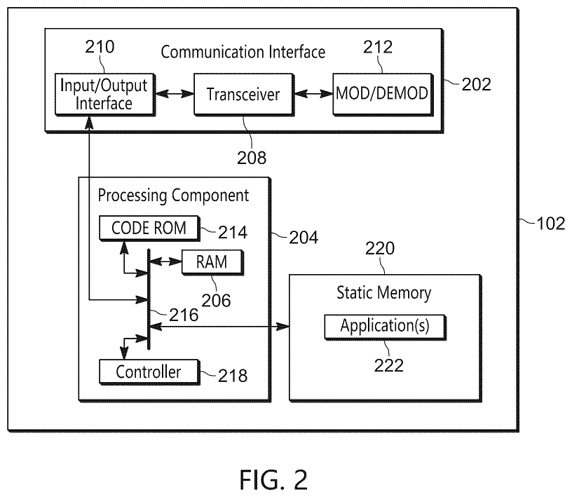

Attention is next directed to FIG. 2, which depicts a schematic block diagram of an example of the computing device 102. While the computing device 102 is depicted in FIG. 2 as a single component, functionality of the computing device 102 may be distributed among a plurality of components and the like including, but not limited to, any suitable combination of one or more servers, one or more cloud computing devices, and the like.

As depicted, the computing device 102 comprises: a communication interface 202, a processing unit 204, a Random-Access Memory (RAM) 206, one or more wireless transceivers 208 (e.g., which may be optional), one or more wired and/or wireless input/output (I/O) interfaces 210, a combined modulator/demodulator 212, a code Read Only Memory (ROM) 214, a common data and address bus 216, a controller 218, and a static memory 220 storing at least one application 222. Hereafter, the at least one application 222 will be interchangeably referred to as the application 222. Furthermore, while the memories 206, 214 are depicted as having a particular structure and/or configuration, (e.g., separate RAM 206 and ROM 214), memory of the computing device 102 may have any suitable structure and/or configuration. Furthermore, a portion of the memory 220 may comprise the memory 134.

While not depicted, the computing device 102 may include, and/or be in communication with, one or more of an input device and a display screen (and/or any other suitable notification device) and the like, such as the input device 118 and/or the display screen 116 of the terminal 112, and the like.

As shown in FIG. 2, the computing device 102 includes the communication interface 202 communicatively coupled to the common data and address bus 216 of the processing unit 204.

The processing unit 204 may include the code Read Only Memory (ROM) 214 coupled to the common data and address bus 216 for storing data for initializing system components. The processing unit 204 may further include the controller 218 coupled, by the common data and address bus 216, to the Random-Access Memory 206 and the static memory 220.

The communication interface 202 may include one or more wired and/or wireless input/output (I/O) interfaces 210 that are configurable to communicate with other components of the system 100. For example, the communication interface 202 may include one or more wired and/or wireless transceivers 208 for communicating with other suitable components of the system 100. Hence, the one or more transceivers 208 may be adapted for communication with one or more communication links and/or communication networks used to communicate with the other components of the system 100. For example, the one or more transceivers 208 may be adapted for communication with one or more of the Internet, a digital mobile radio (DMR) network, a Project 25 (P25) network, a terrestrial trunked radio (TETRA) network, a Bluetooth network, a Wi-Fi network, for example operating in accordance with an IEEE 802.11 standard (e.g., 802.11a, 802.11b, 802.11g), an LTE (Long-Term Evolution) network and/or other types of GSM (Global System for Mobile communications) and/or 3GPP (3^{rd} Generation Partnership Project) networks, a 5G network (e.g., a network architecture compliant with, for example, the 3GPP TS 23 specification series and/or a new radio (NR) air interface compliant with the 3GPP TS 38 specification series) standard), a Worldwide Interoperability for Microwave Access (WiMAX) network, for example operating in accordance with an IEEE 802.16 standard, and/or another similar type of wireless network. Hence, the one or more transceivers 208 may include, but are not limited to, a cell phone transceiver, a DMR transceiver, P25 transceiver, a TETRA transceiver, a 3GPP transceiver, an LTE transceiver, a GSM transceiver, a 5G transceiver, a Bluetooth transceiver, a Wi-Fi transceiver, a WiMAX transceiver, and/or another similar type of wireless transceiver configurable to communicate via a wireless radio network.

It is understood that the DMR transceivers, P25 transceivers, and TETRA transceivers may be particular to first responder devices, and hence such transceivers may be used to communicate with the communication device 108 when the communication device 108 comprises a first responder device and/or radios, and the like.

The communication interface 202 may further include one or more wireline transceivers 208, such as an Ethernet transceiver, a USB (Universal Serial Bus) transceiver, or similar transceiver configurable to communicate via a twisted pair wire, a coaxial cable, a fiber-optic link, or a similar physical connection to a wireline network. The transceiver 208 may also be coupled to a combined modulator/demodulator 212.

The controller 218 may include ports (e.g., hardware ports) for coupling to other suitable hardware components of the system 100.

The controller 218 may be implemented as a plurality of processors, one or more multi-core processors, or specialized hardware accelerators such as Graphics Processing Units (GPUs), Tensor Processing Units (TPUs), or similar parallel processing units optimized for handling large-scale data and complex machine learning models. The controller 218 may be configured to execute different programming instructions, including those optimized for artificial intelligence and/or machine learning tasks. Alternatively, or in addition, the controller 218 may include one or more ASIC (application-specific integrated circuits) and one or more FPGA (field-programmable gate arrays), and/or another electronic device.

In some examples, the controller 218 and/or the computing device 102 is not a generic controller and/or a generic device, but a device specifically configured to implement functionality for obtaining and encoding information into a communication session. For example, in some examples, the computing device 102 and/or the controller 218 specifically comprises a computer executable engine configured to implement functionality for obtaining and encoding information into a communication session.

The static memory 220 comprises a non-transitory machine readable medium that stores machine readable instructions to implement one or more programs or applications. Example machine readable media include a non-volatile storage unit (e.g., Erasable Electronic Programmable Read Only Memory (“EEPROM”), Flash Memory) and/or a volatile storage unit (e.g., random-access memory (“RAM”)). In the example of FIG. 2, programming instructions (e.g., machine readable instructions) that implement the functionality of the computing device 102 as described herein are maintained, persistently, at the memory 220 and used by the controller 218, which makes appropriate utilization of volatile storage during the execution of such programming instructions.

The application 222 may further comprise one or more sets of programming instructions that, when executed by the controller 218, enables the controller 218 to implement the engines 104, 146, 154 (e.g., and the engine 124 when implemented by the computing device 102).

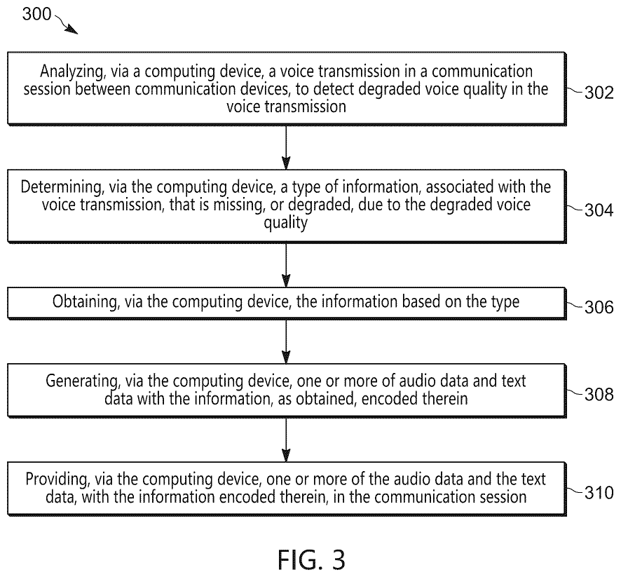

Regardless, it is understood that the memory 220 stores instructions corresponding to the at least one application 222 that, when executed by the controller 218, enables the controller 218 to implement functionality for obtaining and encoding information into a communication session, including, but not limited to, the blocks of the process set forth in FIG. 3.

While not depicted, the application 222 may generally include modules for implementing the engines 104, 146, 154 (e.g., and the engine 124 when implemented by the computing device 102), and the like.

The application 222 may include programmatic algorithms, and the like, to implement functionality as described herein.

Alternatively, and/or in addition, application 222 may include one or more machine learning algorithms that may include, but are not limited to: generative artificial intelligence algorithms, a deep-learning based algorithm; a neural network; a generalized linear regression algorithm; a random forest algorithm; a support vector machine algorithm; a gradient boosting regression algorithm; a decision tree algorithm; a generalized additive model; evolutionary programming algorithms; Bayesian inference algorithms, reinforcement learning algorithms, and the like. Any suitable machine learning algorithm and/or deep learning algorithm and/or neural network is within the scope of present examples.

When one or more machine learning algorithm are used to implement such functionality, the one or more machine learning algorithm may be trained to detect degraded voice quality and/or determine a type of information that is missing from a voice transmission and/or to obtain such missing information. Such training may occur using, for example, appropriate (e.g., positive and/or negative) training data that may be manually generated, or generated by a training data generation computing device.

While details of the communication device 108 and the terminal 112 are not depicted, the communication device 108 and the terminal 112 may have components similar to the computing device 102 adapted, however, for the functionality thereof.

Attention is now directed to FIG. 3, which depicts a flowchart representative of a process 300 for obtaining and encoding information into a communication session. The operations of the process 300 of FIG. 3 correspond to machine readable instructions that are executed by the computing device 102, and specifically the controller 218 of the computing device 102. In the illustrated example, the instructions represented by the blocks of FIG. 3 are stored at the memory 220 for example, as the application 222. The process 300 of FIG. 3 is one way that the controller 218 and/or the computing device 102 and/or the system 100 may be configured. Furthermore, the following discussion of the process 300 of FIG. 3 will lead to a further understanding of the system 100, and its various components.

The process 300 of FIG. 3 need not be performed in the exact sequence as shown and likewise various blocks may be performed in parallel rather than in sequence. Accordingly, the elements of process 300 are referred to herein as “blocks” rather than “steps.” The process 300 of FIG. 3 may be implemented on variations of the system 100 of FIG. 1, as well.

Furthermore, while the process 300 is described without reference to the engines 104 be implemented via one or more of the engines 104, 124, 146, 154.

At a block 302, the controller 218, and/or the computing device 102, analyzes a voice transmission 126 in a communication session 110 between communication devices 108, 112 (e.g., the terminal 112 may comprise a communication device), to detect degraded voice quality in the voice transmission 126.

At a block 304, the controller 218, and/or the computing device 102, determines a type of information, associated with the voice transmission 126, that is missing, or degraded, due to the degraded voice quality.

At a block 306, the controller 218, and/or the computing device 102, obtains the information based on the type.

At a block 308, the controller 218, and/or the computing device 102, generates one or more of audio data and text data with the information, as obtained, encoded therein.

At a block 310, the controller 218, and/or the computing device 102, provides one or more of the audio data and the text data, with the information encoded therein, in the communication session 110.

In some examples, at the block 302, analyzing the voice transmission 126 to detect degraded voice quality in the voice transmission 126 may comprise: comparing the voice transmission 126 with a voiceprint 136 of a user 106 that originated the voice transmission 126.

Alternatively, or in addition, at the block 302, analyzing the voice transmission 126 to detect degraded voice quality in the voice transmission 126 may comprise: determining that one or more of given frequencies, given sounds and given patterns 140 are present in the voice transmission 126.

Alternatively, or in addition, at the block 302, analyzing the voice transmission 126 to detect degraded voice quality in the voice transmission 126 may comprise: determining a change in speech in the voice transmission 126.

Alternatively, or in addition, at the block 302, analyzing the voice transmission 126 to detect degraded voice quality in the voice transmission 126 may comprise: determining that one or more of given words and given phrases 138 are present in the voice transmission 126.

In some examples, at the block 304, determining the type of information may be based on: the voice transmission 126 itself.

Alternatively, or in addition, at the block 304, determining the type of information may be based on: an information request received in the voice transmission 126, in the communication session 110.

In some examples, at the block 306, obtaining the information based on the type may occur using one or more of: sensor data 148, 150 associated with the communication session 110; an information request received in the voice transmission 126 in the communication session 110; call center data 144 associated with the communication session 110; and user records 142 associated with the communication session 110.

The process 300 may include other features.

For example, the process 300 may further comprise one or more of: receiving, in the communication session 110, a confirmation of the information encoded in one or more of the audio data and the text data; and providing, in the communication session 110, an indication of the confirmation. For example, when the information encoded in one or more of the audio data and the text data is received at the communication device 108 in the communication session 110, the user 106 may operate the communication device 108 to confirm the information. Such a confirmation may optionally be provided in the communication session 110 so that the terminal 112 receives such a confirmation as audio data and/or text data, though the absence of such audio data and/or text data may also indicate that a confirmation was received.

Alternatively, or in addition, the process 300 may further comprise: receiving sensor data 148, 150 associated with the information; and augmenting the information, encoded in one or more of the audio data and the text data, respective information determined from the sensor data 148, 150. For example, when the information obtained at the block 306, excludes one or more sets of the sensor data 148, 150, a portion of the sensor data 148, 150 may nonetheless be used to augment the information. For example, the sensor data 150 may indicate that chlorine gas is present at the location of the user 106, and the information may be augmented by including an indication that chlorine gas is present at the location of the user therein.

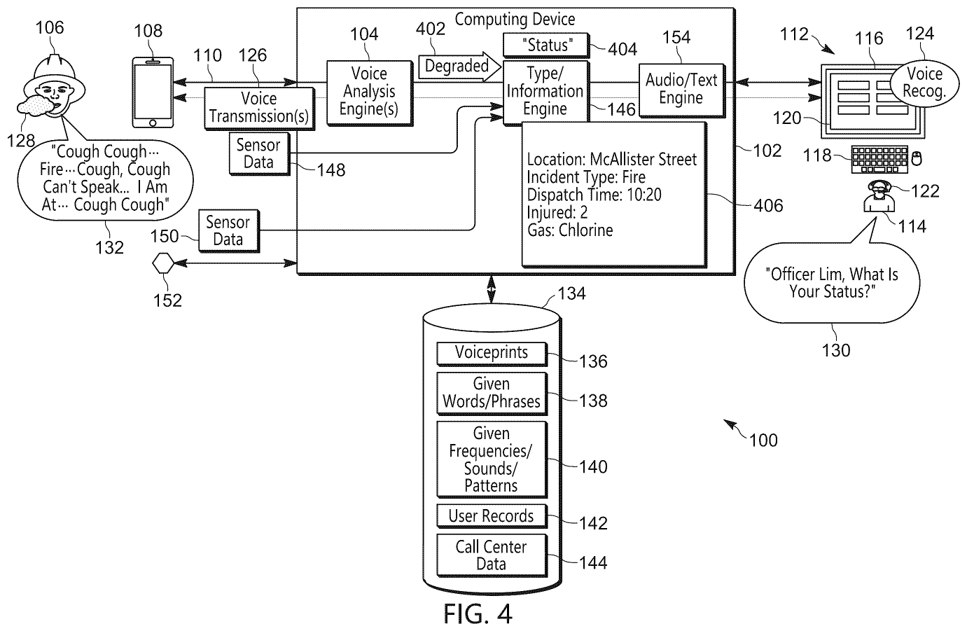

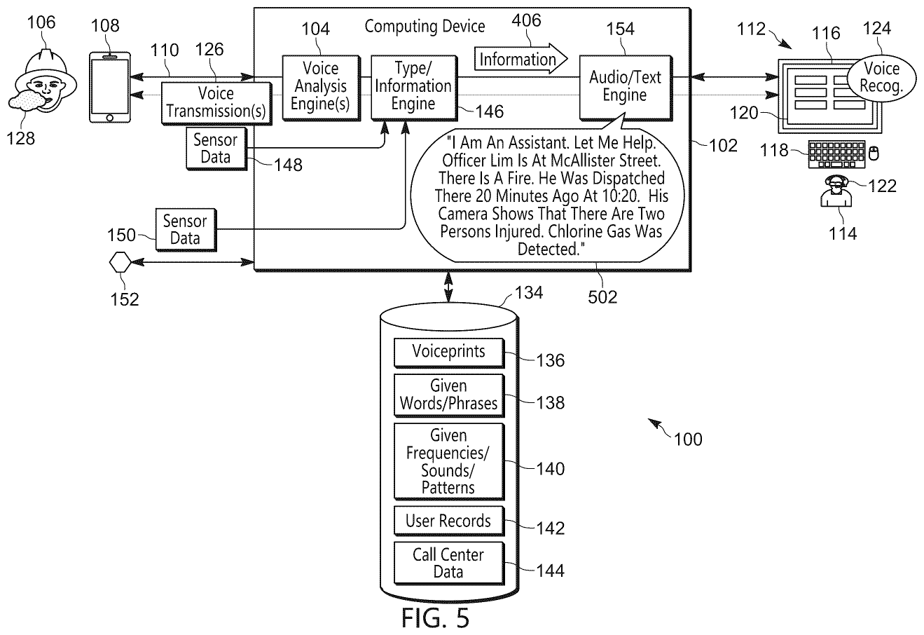

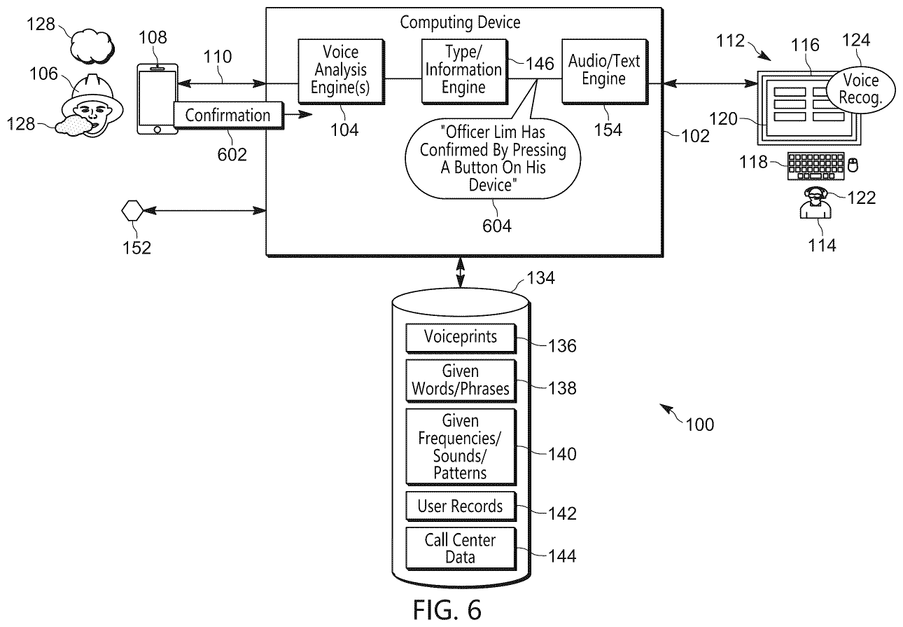

Attention is next directed to FIG. 4, FIG. 5, and FIG. 6, that depict aspects of the process 300. FIG. 4, FIG. 5, and FIG. 6, are substantially similar to FIG. 1 with like components having like numbers.

Attention is next directed to FIG. 4, which depicts the voice analysis engine 104 analyzing (e.g., at the block 302 of the process 300) the voice transmission 126 and detecting degraded voice quality in the voice transmission 126. For example, an arrow 402 labelled with “Degraded” may represent an output of the voice analysis engine 104 that indicates such degraded voice quality in the voice transmission 126. While not depicted, the voice analysis engine 104 may retrieve one or more of the voiceprint 136 of the user 106, the given words and/or phrases 138, and the given frequencies and/or sounds and/or patterns 140 from the memory 134 to assist in detecting the degraded voice quality.

As also depicted in FIG. 4, the engine 146 may receive the output of the voice analysis engine 104 and responsively determine (e.g., at the block 304 of the process 300) a type of information, associated with the voice transmission 126, that is missing, or degraded, due to the degraded voice quality. For example, as depicted a type 404 of such information comprises a “Status” of the user 106, as described herein. In particular, the engine 146 may determine the information that is missing, such as details of the “fire” and/or the location of the user 106, as is next described.

As also depicted in FIG. 4, the engine 146 may further obtain and/or determine (e.g., at the block 306 of the process 300) information 406, that indicates the status of the user 106, using the sensor data 148, 150 and/or any other suitable data, such as the user records 142 and/or the call center data 144. For example, as depicted, the information 406 comprises:
Location: Mcallister Street
Incident type: fire
Dispatch time: 10:20
Injured: 2
Gas: Chlorine

While some of the depicted information 406 includes information that is not directly indicative of a status of the user 106 (e.g., information identifying the number of injured persons or the presence of certain gases in the air), such information is indicative of the immediate environment of the user 106 and is, therefore, treated as information that indicates the status of the user 106 for purposes of the present disclosure. Furthermore, the depicted information 406, as depicted, may be in a format provided by one or more of the sensor data 148, the sensor data 150, the user records 142 and/or the call center data 144.

It is understood that the information of “Location: McAllister Street” may be from GPS data of the sensor data 148, the information of “Incident type: fire” may be from image data of the sensor data 148, 150 (and/or from the user records 142 and/or the call center data 144, e.g., from an incident report), the information of “Dispatch time: 10:20” may be from the user records 142 and/or the call center data 144 (e.g., from an incident report), and the information of “Injured: 2” may be from image data of the sensor data 148, 150. The information of “Gas: chlorine” may be from the sensor data 150.

With attention next directed to FIG. 5, the engine 146 may provide the information 406 to the audio and/or text engine 154, which may generate (e.g., at the block 308 of the process 300) audio data and/or text data from the information 406. For example, as depicted, the engine 154 has generated audio data 502, from the information 406, comprising: “I am an assistant. Let me help. Officer Lim is at McAllister Street. There is a fire. He was dispatched there 20 minutes ago at 10:20. His camera shows that there are two persons injured. Chlorine gas was detected.”

In particular, the audio data 502 is depicted in a speech bubble to indicate that the audio data 502 is provided (e.g., at the block 310 of the process 300), in the communication session 110, to the communication device 108 and the terminal 112, so that both the user 106 and the operator 114 hear the audio data 502 and/or so that the audio data 502 may be converted to text by the voice recognition engine 124 (though, alternatively, text data corresponding to the information 406 may be provided in place of the voice recognition engine 124 converting the audio data 502 to text).

Furthermore, as depicted, it is understood that the engine 154 has converted the information 406 to a conversational format of the audio data 502, for example using an LLM, and the like. Alternatively, or in addition, such a conversion may occur via the engine 146 and/or any other suitable engine. However, such a conversion may be optional.

Alternatively, or in addition, text data that comprises “I am an assistant. Let me help. Officer Lim is at McAllister Street. There is a fire. He was dispatched there 20 minutes ago at 10:20. His camera shows that there are two persons injured. Chlorine gas was detected.” may be provided, in the communication session 110, to the communication device 108 and the terminal 112.

Hence, the audio data 502 generally corresponds to the information 406, with the addition of “I am an assistant. Let me help”, which indicates that the audio data 502 was generated by way of the engines 104, 146, 154.

With further reference to FIG. 5, the speech bubbles 130, 132 are removed as the user 106 and the operator 114 may have at least temporarily stopped talking.

The audio data 502 hence provides the information 406 missing in the voice transmissions 126 due to speech of the user 106 being degraded, which may generally improve efficiency of processing of such information 406 by the voice recognition engine 124. It is further understood that the audio data 502 may further obviate the user 106 attempting to repeat attempts at saying such information 406, which may save bandwidth in the system 100 and/or processing resources in the system 100 (e.g., as each attempt may be converted from audio to text via the voice recognition engine 124).

Attention is next directed to FIG. 6, which depicts the communication device 108 providing a confirmation 602 in the communication session 110, which may occur by way of the user 106 operating the communication device 108 to generate the confirmation 602, for example by actuating a button and/or an electronic button, and the like at the communication device 108. For example, the user 106 may hear the audio data 502 and operate the communication device 108 to confirm the information of the audio data 502 by actuating a button and/or an electronic button, and the like at the communication device 108 as the user 106 may otherwise be unable to talk.

While the sensor data 148, 150 is not depicted for simplicity in FIG. 6, it may nonetheless be present.

In response to receiving the confirmation 602, the computing device 102 may optionally generate further audio data 604 in the communication session 110 that indicates receiving the confirmation 602. For example the further audio data 604 is again shown as a speech bubble with “Officer Lim Has Confirmed By Pressing A Button On His Device” indicating that the audio data 502 has been confirmed. The audio data 604 may be generated via the engine 154 and/or any other suitable component of the computing device 102.

In the event that the user 106 operates the communication device 108 to indicate that the audio data 502 is not confirmed, and/or to indicate that the audio data 502 includes an error, respective audio data indicating non-confirmation and/or an error may be provided in the communication session 110. In some these examples, the user 106 may be provided with a list of items in the audio data 502, for example at a display screen of the communication device 108, and the user may confirm, or not confirm, each item. Continuing with the example information 406, such a list may comprise menu items, as follows, which may be respectively selected or deselected (and/or not selected) to confirm, or not confirm, each item:
Officer Lim is at McAllister Street.
There is a fire.
He was dispatched there 20 minutes ago at 10:20.
His camera shows that there are two persons injured.
Chlorine gas was detected.

In a particular example, the user 106 may confirm each item other than “His camera shows that there are two persons injured”, and confirmed items may be provided in corrected audio data (not depicted) that may comprise “Officer Lim is correcting the previously provided information as follows. Officer Lim is at McAllister Street. There is a fire. He was dispatched there 20 minutes ago at 10:20. Chlorine gas was detected. His camera does not show that there are two persons injured.”

In some of these examples, the list of menu items may include options, such as fields, to correct an item when incorrect. For example, rather than two persons injured, three persons may be injured, and the user 106 may indicate same in a respective menu item and/or field. In these examples, corrected audio data (not depicted) may comprise “Officer Lim is correcting the previously provided information as follows. Officer Lim is at McAllister Street. There is a fire. He was dispatched there 20 minutes ago at 10:20. Chlorine gas was detected. There are three persons injured, not two persons injured as previously reported.”

As should be apparent from this detailed description above, the operations and functions of electronic computing devices described herein are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot generate or process voiceprints, cannot operate machine learning algorithms, and the like).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together). Similarly the terms “at least one of” and “one or more of”, without a more limiting modifier such as “only one of”, and when applied herein to two or more subsequently defined options such as “at least one of A or B”, or “one or more of A or B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context, in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method comprising:
analyzing, via a computing device, a voice transmission in a communication session between communication devices, to detect degraded voice quality in the voice transmission;
determining, via the computing device, a type of information, associated with the voice transmission, that is missing, or degraded, due to the degraded voice quality;
obtaining, via the computing device, the information based on the type;
generating, via the computing device, one or more of audio data and text data with the information, as obtained, encoded therein; and
providing, via the computing device, one or more of the audio data and the text data, with the information encoded therein, in the communication session.

2. The method of claim 1, wherein analyzing the voice transmission to detect degraded voice quality in the voice transmission comprises:
comparing the voice transmission with a voiceprint of a user that originated the voice transmission.

3. The method of claim 1, wherein analyzing the voice transmission to detect degraded voice quality in the voice transmission comprises:
determining that one or more of given frequencies, given sounds and given patterns are present in the voice transmission.

4. The method of claim 1, wherein analyzing the voice transmission to detect degraded voice quality in the voice transmission comprises:
determining a change in speech in the voice transmission.

5. The method of claim 1, wherein analyzing the voice transmission to detect degraded voice quality in the voice transmission comprises:
determining that one or more of given words and given phrases are present in the voice transmission.

6. The method of claim 1, wherein determining the type of information is based on:
the voice transmission itself.

7. The method of claim 1, wherein determining the type of information is based on:
an information request received in the communication session.

8. The method of claim 1, wherein obtaining the information based on the type occurs using one or more of:
sensor data associated with the communication session;
an information request received in the communication session;
call center data associated with the communication session; and
user records associated with the communication session.

9. The method of claim 1, further comprising one or more of:
receiving, in the communication session, a confirmation of the information encoded in one or more of the audio data and the text data; and
providing, in the communication session, an indication of the confirmation.

10. The method of claim 1, further comprising:
receiving sensor data associated with the information; and
augmenting the information, encoded in one or more of the audio data and the text data, respective information determined from the sensor data.

11. A computing device comprising:
a controller; and
a computer-readable storage medium having stored thereon program instructions that, when executed by the controller, causes the controller to perform a set of operations comprising:
analyzing a voice transmission in a communication session between communication devices, to detect degraded voice quality in the voice transmission;
determining a type of information, associated with the voice transmission, that is missing, or degraded, due to the degraded voice quality;
obtaining the information based on the type;
generating one or more of audio data and text data with the information, as obtained, encoded therein; and
providing one or more of the audio data and the text data, with the information encoded therein, in the communication session.

12. The computing device of claim 11, wherein analyzing the voice transmission to detect degraded voice quality in the voice transmission comprises:
comparing the voice transmission with a voiceprint of a user that originated the voice transmission.

13. The computing device of claim 11, wherein analyzing the voice transmission to detect degraded voice quality in the voice transmission comprises:
determining that one or more of given frequencies, given sounds and given patterns are present in the voice transmission.

14. The computing device of claim 11, wherein analyzing the voice transmission to detect degraded voice quality in the voice transmission comprises:
determining a change in speech in the voice transmission.

15. The computing device of claim 11, wherein analyzing the voice transmission to detect degraded voice quality in the voice transmission comprises:
determining that one or more of given words and given phrases are present in the voice transmission.

16. The computing device of claim 11, wherein determining the type of information is based on:
the voice transmission itself.

17. The computing device of claim 11, wherein determining the type of information is based on:
an information request received in the communication session.

18. The computing device of claim 11, wherein obtaining the information based on the type occurs using one or more of:
sensor data associated with the communication session;
an information request received in the communication session;
call center data associated with the communication session; and
user records associated with the communication session.

19. The computing device of claim 11, wherein the set of operations further comprises one or more of:
receiving, in the communication session, a confirmation of the information encoded in one or more of the audio data and the text data; and
providing, in the communication session, an indication of the confirmation.

20. The computing device of claim 11, wherein the set of operations further comprises:
receiving sensor data associated with the information; and
augmenting the information, encoded in one or more of the audio data and the text data, respective information determined from the sensor data.
